(19) United States
(12) Patent Application Publication
(10) Pub. No.: US 2015/0371601 A1
(43) Pub. Date: Dec. 24, 2015

(54) DISPLAY DEVICE AND DRIVING METHOD THEREOF

(71) Applicant: Samsung Display Co. Ltd., Yongin-City (KR)

(72) Inventor: Ho-Young Kim, Cheonan-si (KR)

(21) Appl. No.: 14/574,006

(22) Filed: Dec. 17, 2014

(30) Foreign Application Priority Data
Jun. 18, 2014 (KR) 10-2014-0074560

(51) Int. Cl. G09G 3/36; G06F 1/28

(52) U.S. Cl. CPC G09G 3/3696; G09G 3/3655; G06F 1/28; G09G 2320/02; G09G 2330/022

(57) ABSTRACT

A display device and method of driving the same is provided. A display device includes a first signal controller configured to be turned on by a first signal among a plurality of signals applied thereto at an early stage of driving, and to output the plurality of signals applied at the early stage of driving in a predefined order, and a main power integrated circuit (IC) configured to be turned on when each of the plurality of signals applied at the early stage of driving is received, wherein the first signal controller comprises a standby power supply portion configured to supply standby power to the first signal controller while the main power IC is off.

### CROSS-REFERENCE TO RELATED APPLICATION

This application claims priority to and the benefit of Korean Patent Application No. 10-2014-0074560 filed on Jun. 18, 2014 in the Korean Intellectual Property Office, the disclosure of which is incorporated herein by reference in its entirety.

### BACKGROUND

1. Field

Embodiments of the present invention relate to a display device and a driving method thereof.

2. Description of the Related Art

A variety of display devices have been developed and used in accordance with recent trends toward light-weighted, thin display devices for home appliances such as televisions (TVs) and monitors, and also for mobile terminals such as notebook computers, mobile phones and portable media players (PMPs). A display device may include a display panel for displaying an image, and may be classified into, for example, a liquid crystal display (LCD) device, an organic light-emitting display device and an electrophoretic display (EPD) device according to the type of the display panel.

A display device displays an image on a display panel thereof by using control signals applied thereto from an external source. In response to an input voltage being supplied to the display device for a first time, that is, at an early stage of driving, an over-current may flow into the display device through a main switch. A power integrated circuit (IC) may be driven a predetermined amount of time after the early stage of the driving of the display device and may prevent the generation of an over-current thereafter. However, since the power IC is not driven at the early stage of the driving of the display device, the generation of an over-current cannot be prevented at the early stage of the driving of the display device.

An over-current generated at the early stage of the driving of the display device may cause severe stress, and even damage, to various elements of the display device, such as the main switch, a driving IC and the display panel, and as a result, the display device may not be able to properly display an image.

### SUMMARY

Exemplary embodiments of the present invention provide a display device capable of detecting and controlling an over-current at an early stage of driving.

However, exemplary embodiments of the present invention are not limited to those set forth herein. The above and other exemplary embodiments of the present invention will become more apparent to one of ordinary skill in the art to which this application pertains by referencing the detailed description of embodiments of the present invention given below.

According to an exemplary embodiment of the present invention, a display device including a first signal controller configured to be turned on by a first signal among a plurality of signals applied thereto at an early stage of driving, and to output the plurality of signals applied at the early stage of driving in a predefined order, and a main power integrated circuit (IC) configured to be turned on when each of the plurality of signals applied at the early stage of driving is received, wherein the first signal controller includes a standby power supply portion configured to supply standby power to the first signal controller while the main power IC is off.

The first signal controller may further include a signal detection portion, configured to detect the first signal and outputs a start signal, a reference signal order provider, configured to output a reference signal order in which the plurality of signals applied at the early stage of driving should be output when the start signal is received, and a comparator, configured to, when the start signal is received, output an over-current protection signal when an order of the application of the plurality of signals applied at the early stage of driving does not coincide with the reference signal order output by the reference signal order provider.

The first signal controller may further include a blocking portion configured to block the transmission of a plurality of power voltage control signals of the plurality of signals by the comparator for an amount of time when the over-current protection signal is received.

The blocking portion may be configured to feed the power voltage control signals back to the comparator.

The first signal controller may further include a blocking portion configured to block the transmission of a plurality of power voltage control signals of the plurality of signals and an input image signal of the plurality of signals by the comparator for an amount of time when the over-current protection signal is received.

The blocking portion may be configured to feed the power voltage control signals and the input image signal back to the comparator.

The plurality of signals applied at the early stage of driving may include a first power voltage signal; a second power voltage signal; and an input image signal, and the first power voltage signal, the second power voltage signal, and the input image signal may be sequentially applied to the main power IC.

The reference signal order provider may be turned off when the signals applied at the early stage of driving are applied to the first signal controller in the predefined order.

The standby power supply portion may be turned off when the signals applied at the early stage of driving are applied to the main power IC in the predefined order.

The comparator may include a differential amplifier.

The comparator may include an AND operator.

The display device may further include a second signal controller configured to be driven by the main power IC, to be connected to the first signal controller and to provide an input image signal to a display panel.

According to another embodiment of the present invention, there is provided a method of driving a display device, the method including allowing a first signal controller to be turned on by a first signal, among a plurality of signals applied thereto at an early stage of driving; determining whether an order of the application of the plurality of signals applied at the early stage of driving coincides with a predefined order; outputting the signals applied at the early stage of driving in the predefined order; and allowing a main power IC to be turned on when each of the signals applied at the early stage of driving is received, wherein the first signal controller includes a standby power supply portion, which supplies standby power to the first signal controller while the main power IC is off.

The first signal controller may further include a signal detection portion, which detects the first signal and outputs a start signal, a reference signal order provider, which outputs a reference signal order in which the signals applied at the early stage of driving should be output when the start signal is received, and a comparator, which, when the start signal is received, outputs an over-current protection signal when an order of the application of the signals applied at the early stage of driving does not coincide with the reference signal order output by the reference signal order provider.

The first signal controller may further include a blocking portion which blocks the transmission of a plurality of power voltage control signals of the plurality of signals by the comparator for an amount of time when the over-current protection signal is received.

The blocking portion may feed the power voltage control signals back to the comparator.

The first signal controller may further include a blocking portion which blocks the transmission of a plurality of power voltage control signals of the plurality of signals and an input image signal of the plurality of signals by the comparator for an amount of time when the over-current protection signal is received.

The blocking portion may feed the power voltage control signals and the input image signal back to the comparator.

The plurality of signals applied at the early stage of driving may include: a first power voltage signal; a second power voltage signal; and an input image signal, and the first power voltage signal, the second power voltage signal, and the input image signal are sequentially applied to the main power IC.

The reference signal order provider may be turned off when the signals applied at the early stage of driving are applied to the first signal controller in the predefined order and the standby power supply portion is turned off when the signals applied at the early stage of driving are applied to the main power IC in the predefined order.

According to the exemplary embodiments, it is possible to provide a display device capable of detecting and controlling an over-current at an early stage of driving.

Other features and exemplary embodiments will be apparent from the following detailed description, the drawings, and the claims.

### BRIEF DESCRIPTION OF THE DRAWINGS

The above and other aspects and features of embodiments of the present invention will become more apparent by describing in detail exemplary embodiments thereof with reference to the attached drawings, in which:

FIG. 1 is a block diagram of a display device according to an exemplary embodiment of the present invention.

FIG. 2 is an equivalent circuit diagram of a pixel illustrated in FIG. 1.

FIG. 3 is a block diagram of a first signal controller according to an exemplary embodiment of the present invention.

FIG. 4 is a flowchart illustrating the operation of the first signal controller illustrated in FIG. 3.

FIG. 5 is a timing diagram of a plurality of signals applied at an early stage of driving, according to an exemplary embodiment of the present invention.

FIG. 6 is a block diagram of a first signal controller according to another exemplary embodiment of the present invention.

FIGS. 7 and 8 are timing diagrams of a plurality of signals applied at an early stage of driving, according to another exemplary embodiment of the present invention.

FIG. 9 is a block diagram of a first signal controller according to another exemplary embodiment of the present invention.

FIG. 10 is a timing diagram of a plurality of signals applied at an early stage of driving, according to another exemplary embodiment of the present invention.

FIG. 11 is a block diagram of a first signal controller according to another exemplary embodiment of the present invention.

FIG. 12 is a flowchart illustrating the operation of the first signal controller illustrated in FIG. 11.

FIGS. 13 and 14 are circuit diagrams of first comparators according to exemplary embodiments of the present invention.

FIG. 15 is a timing diagram illustrating the operation of the first comparator illustrated in FIG. 14.

### DETAILED DESCRIPTION

Aspects and features of embodiments of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concepts of the present invention to those skilled in the art. Thus, in some embodiments, well-known structures and devices are not shown in order to avoid obscuring the description of the embodiments with unnecessary detail. Like numbers refer to like elements throughout. In the drawings, the thickness of layers and regions are exaggerated for clarity.

It will be understood that when an element or layer is referred to as being “on,” “connected to,” “coupled to”, or “adjacent to” another element or layer, it can be directly on, connected to, coupled to, or adjacent to the other element or layer, or one or more intervening elements or layers may be present. In contrast, when an element is referred to as being “directly on,” “directly connected to,” “directly coupled to”, or “immediately adjacent to” another element or layer, there are no intervening elements or layers present. As used herein, the term “and/or” includes any and all combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments described herein will be described referring to plan views and/or cross-sectional views by way of ideal schematic views of the embodiments of the present invention. Accordingly, the exemplary views may be modified depending on manufacturing technologies and/or tolerances. Therefore, the embodiments of the present invention are not limited to those shown in the views, but include modifications in configuration formed on the basis of manufacturing processes. Therefore, regions that are exemplified in the figures have exemplary schematic properties and shapes and do not limit the present invention to only those exemplary schematic properties and shapes.

Hereinafter, embodiments of the present invention will be described with reference to the attached drawings.

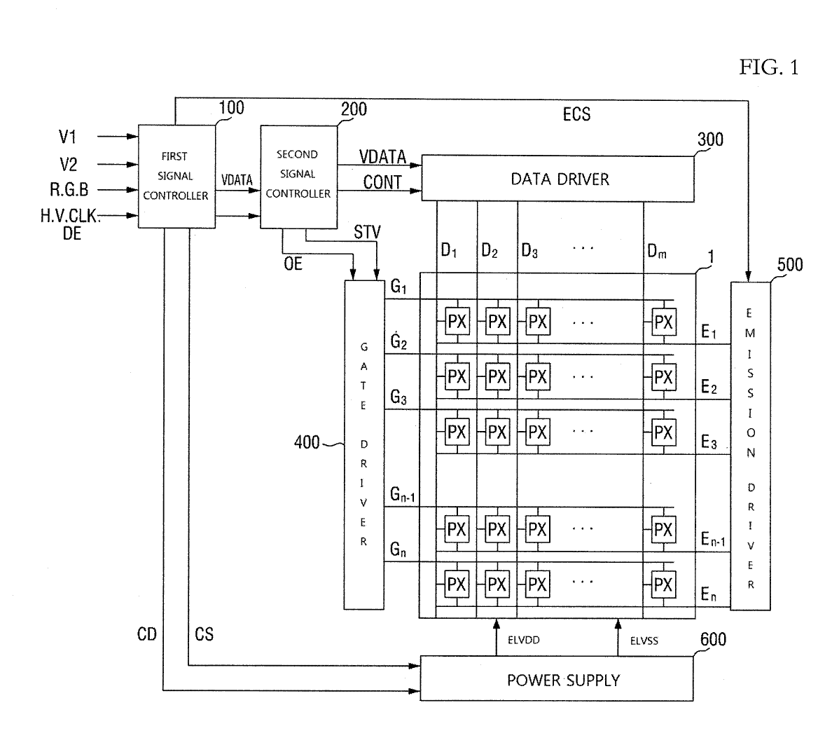

FIG. 1 is a block diagram of a display device according to an exemplary embodiment of the present invention. Referring to FIG. 1, the display device may include a display panel 1 having a plurality of pixels PX, a first signal controller 100 and a second signal controller 200.

The display panel 1 may include a plurality of gate lines G₁, G₂, . . . , Gₙ, a plurality of data lines D₁, D₂, . . . , Dₘ and the pixels PX, which are provided at the intersections between the gate lines G₁, G₂, . . . , Gₙ and the data lines D₁, D₂, . . . , Dₘ. The pixels PX may display a grey level corresponding to a data signal applied thereto via the data lines D₁, D₂, . . . , Dₘ, and may decide or determine whether to receive the data signal in accordance with a gate signal applied thereto via the gate lines G₁, G₂, . . . , Gₙ. The display panel 1 may also include a plurality of emission lines E₁, E₂, . . . , Eₘ. The pixels PX may control the application of a current to their respective organic light-emitting diodes (OLEDs) in accordance with an emission signal applied thereto via the emission lines E₁, E₂, . . . , Eₘ.

The first signal controller 100 receives an input image signal (R, G, B) and an input control signal for controlling the display of the input image signal (R, G, B) from an external graphic controller (not illustrated), and may provide an image signal VDATA and the input control signal to the second signal controller 200. The input control signal may include a horizontal synchronization signal H, a clock signal CLK and a data enable signal DE. The first signal controller 100 may provide the input control signal to the second signal controller 200 without processing the input control signal, but the present invention is not limited thereto. That is, the first signal controller 100 may provide the input control signal to the second signal controller 200 only after shifting or filtering the input control signal.

The second signal controller 200 may receive the input control signal and the image signal VDATA, and may provide a data control signal CONT and the image signal VDATA to a data driver 300. The data control signal CONT is a signal for controlling the operation of the data driver 300, and may include a horizontal start signal for initiating the operation of the data driver 300 and a load signal for giving instructions to output two data voltages.

The data driver 300 may receive the image signal VDATA and the data control signal CONT, and may provide an image data voltage DATA corresponding to the image signal VDATA to each of the data lines D₁, D₂, . . . , Dₘ. The data driver 300 may generate a data voltage including an image data signal in a certain unit. The data driver 300 may be an integrated circuit (IC) connected to the display panel 1 in the form of a tape carrier package (TCP), but the present invention is not limited thereto. That is, the data driver 300 may be provided on a non-display part (not illustrated) of the display panel 1.

The first signal controller 100 may receive a vertical synchronization signal V and the clock signal CLK from the external graphic controller (not illustrated), and may provide the vertical synchronization signal V and the clock signal CLK to the second signal controller 200. The first signal controller 100 may provide the vertical synchronization signal V and the clock signal CLK to the second signal controller 200 without subjecting them to any process, but the present invention is not limited thereto. That is, the first signal controller 100 may provide the vertical synchronization signal V and the clock signal CLK to the second signal controller 200 only after shifting or filtering them.

The second signal controller 200 may receive the vertical synchronization signal V and the clock signal CLK, and may provide a scan start signal STV and a clock generation control signal OE to a gate driver 400. The second signal controller 200 may include a clock generator (not illustrated). The clock generator may receive the clock generation control signal OE, and may output a first clock signal CKV and a second clock signal CKVB. The first clock signal CKV and the second clock signal CKVB may have opposite phases.

The gate driver 400 may be driven by the scan start signal STV, may generate a plurality of gate signals by using the first clock signal CKV and the second clock signal CKVB, and may sequentially apply the gate signals to the gate lines G₁, G₂, . . . , Gₙ.

The first signal controller 100 may receive a first voltage V1 and a second voltage V2 from a voltage source (not illustrated), and may provide a first power control signal CD and a second power control signal CS to a power supply 600 via a signal detection portion 110, a first control portion 130 and a blocking portion 170 thereof.

An emission driver 500 may receive an emission driver control signal ECS, and may generate first through n-th emission signals EM₁ through EMₙ based on the emission driver signal ECS. Each of the first through n-th emission signals EM₁ through EMₙ may have an emission-on voltage or an emission-off voltage, and may be applied to the pixels PX via the first through m-th emission lines E₁ through Eₘ, respectively. In response to an emission signal having the emission-on voltage being received, the OLEDs included in the pixels PX may emit light. In response to an i-th scan signal Sᵢ (where i is a natural number in the range of 1 to n) being switched from a scan-on voltage to a scan-off voltage, an i-th emission signal EMᵢ may be switched from the emission-off voltage to the emission-on voltage.

The power supply 600 may generate a first power voltage ELVDD and a second power voltage ELVSS, and may be controlled by the first power control signal CD and the second power control signal CS.

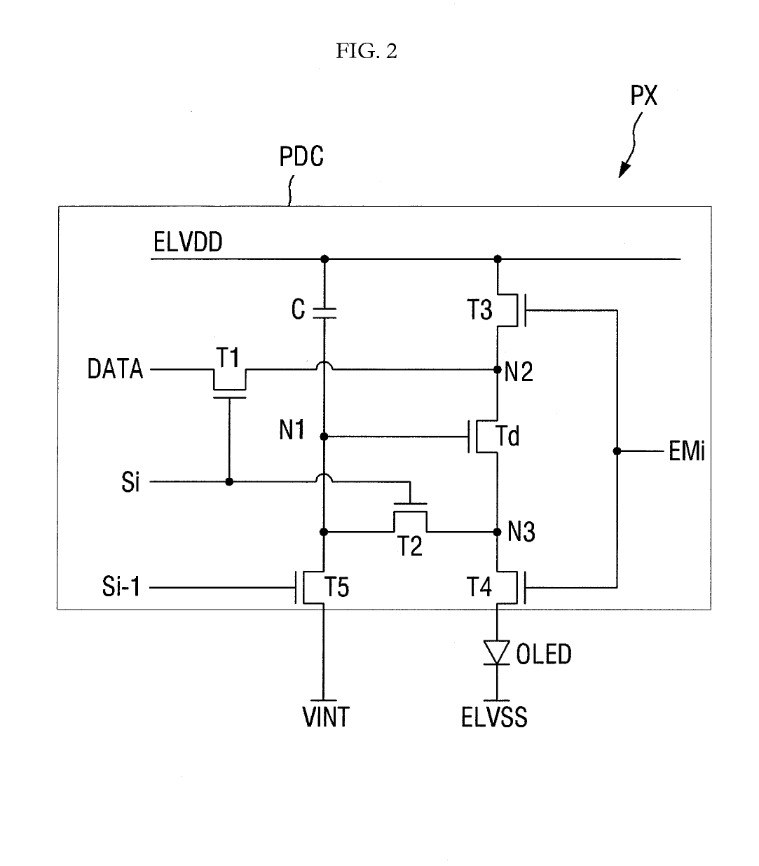

FIG. 2 is an equivalent circuit diagram of an exemplary one of the plurality of pixels PX illustrated in FIG. 1. Referring to FIG. 2, it is assumed that the display panel 1 is an organic light-emitting display panel, but the present invention is not limited thereto. That is, the display panel 1 may be a liquid crystal display (LCD) panel, a plasma display panel, a field emission display (FED) panel, or an electrophoretic display (EPD) panel.

A pixel PX may include a pixel driver PDC and an OLED. The pixel driver PDC may include a first transistor T1, a second transistor T2, a third transistor T3, a fourth transistor T4, a fifth transistor T5, a driving transistor Td, and a driving capacitor C.

The OLED may emit light with a luminance level corresponding to the level of a current that flows from the anode to the cathode thereof. The first power voltage ELVSS may be applied to the cathode of the OLED. The anode of the OLED may be connected to the fourth transistor T4. The fourth transistor T4 may control whether to connect the anode of the OLED to a third node N3.

The driving transistor Td may include a source S connected to a second node N2 to which the second power voltage ELVDD is applied, a drain D connected to the third node N3, and a gate G connected to a first node N1. The pixel PX may receive the image data voltage DATA via the first transistor T1, which is connected to the second node N2 of the driving transistor Td. The driving transistor Td may control a current that flows into the OLED. The level of the current that flows into the OLED may correspond to the difference in potential between the source S and the gate G of the driving transistor Td.

The first transistor T1 may include a source receiving the image data voltage DATA, a drain connected to the second node N2, and a gate receiving the i-th scan signal Sᵢ. In response to the i-th scan signal Sᵢ having the scan-on voltage, the first transistor T1 may be turned on, and as a result, the image signal VDATA may be transmitted to the second node N2.

A first end of the driving capacitor C may be connected to the first node to which the gate G of the driving transistor Td is connected, and the first power voltage ELVDD may be applied to a second end of the driving capacitor C. Accordingly, the driving capacitor C may store therein the voltage at the gate G of the driving transistor Td.

The i-th scan signal Sᵢ may be transmitted to the gate of the second transistor T2. In response to the i-th scan signal Sᵢ having the scan-on voltage, the second transistor T2 may be turned on, and may thus connect the gate G and the drain D of the driving transistor Td, thereby diode-connecting the driving transistor Td. In response to the driving transistor Td being diode-connected, a voltage obtained by subtracting a threshold voltage of the driving transistor Td from the image data voltage DATA, which is applied to the source S of the driving transistor Td, may be applied to the gate G of the driving transistor Td. Since the gate G of the driving transistor Td is connected to the first end of the driving capacitor C, the voltage applied to the gate G of the driving transistor Td may be maintained. Since a voltage into which the threshold voltage of the driving transistor is reflected is applied to the gate G of the driving transistor Td and is maintained, the current that flows between the source S and the drain D of the driving transistor Td may not be affected by the threshold voltage of the driving transistor Td.

The i-th emission signal EMᵢ may be transmitted to the gate of the third transistor T3. In response to the i-th emission signal EMᵢ having the emission-on voltage, the third transistor T3 may be turned on, and may thus provide the first power voltage ELVDD to the second node N2. The i-th emission signal EMᵢ may also be transmitted to the gate of the fourth transistor T4. In response to the i-th emission signal EMᵢ having the emission-on voltage, the third transistor T3 and the fourth transistor T4 may both be turned on. For as long as the i-th emission signal EMᵢ has the emission-on voltage, a current corresponding to the image data voltage DATA, which is present in the driving capacitor C, may be generated between the source S and the drain D of the driving transistor Td, and may then flow into the OLED. As a result, the OLED may emit light.

An (i−1)-th scan signal Sᵢ₋₁ may be applied to the gate of the fifth transistor T5. In response to the (i−1)-th scan signal Sᵢ₋₁ having the scan-on voltage, the fifth transistor T5 may be turned on, and may thus apply an initialization voltage VINT to the gate G of the driving transistor Td, thereby initializing the gate G of the driving transistor Td.

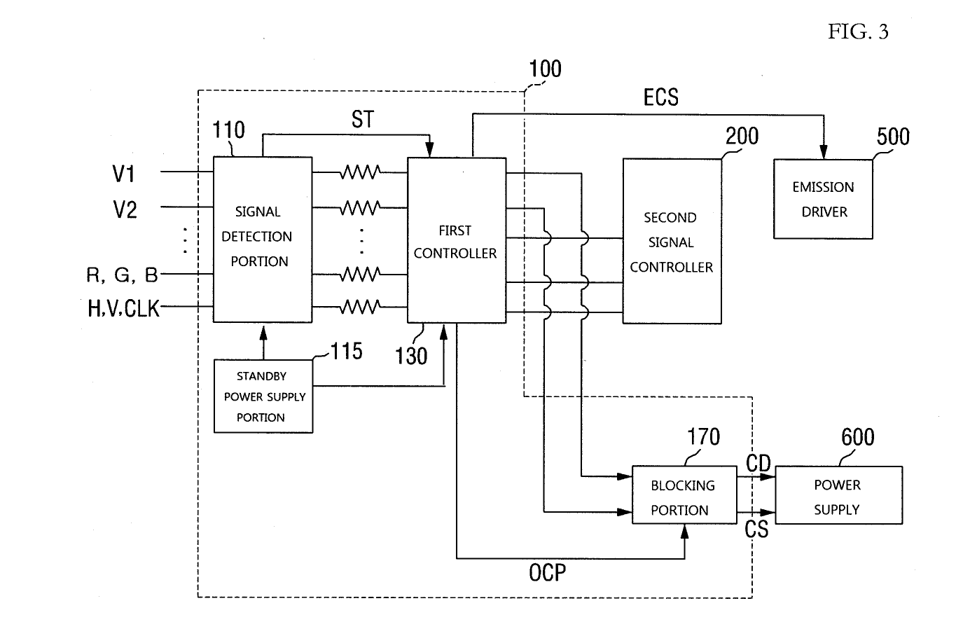

The first signal controller 100 will, hereinafter, be described in detail with reference to FIG. 3.

FIG. 3 is a block diagram of a first signal controller according to an exemplary embodiment of the present invention. Referring to FIG. 3, a signal control unit may include a first signal controller 100 and a second signal controller 200. The first signal controller 100 may include a signal detection portion 110, a first control portion 130 and a blocking portion 170. The signal detection portion 110 may detect a plurality of signals applied to a display device at an early stage of driving. The signal detection portion 110 may include a sensor (not illustrated) for sensing the plurality of signals. The sensor may sense a voltage or a current applied thereto. The plurality of signals may include the input image signal (R, G, B), the image control signal, the horizontal synchronization signal H, the vertical synchronization signal V, the main clock signal CLK, the first voltage V1 and the second voltage V2. The signal detection portion 110 may detect the plurality of signals via the sensor. In response to the plurality of signals being detected (e.g., when the plurality of signals are detected), the signal detection portion 110 may apply a start signal ST to the first control portion 130. The signal detection portion 110 may be provided with standby power by a standby power supply portion 115, and may be able to detect via the sensor thereof more than one signal applied to the first signal controller 100 until a main power IC (not illustrated) is driven. In response to the main power IC being driven, the standby power supply portion 115 may no longer supply standby power to the sensor, and as a result, the signal detection portion 110 may no longer be able to detect signals. In response to the main power IC stopping its operation, the standby power supply portion 115 may resume supplying standby power to the sensor, and as a result, the signal detection portion 110 may be able to continue to detect signals. The operation of the signal detection portion 110 is not limited to the example set forth herein, and may continue to be provided with standby power by the standby power supply portion 115 even when the main power IC is being driven.

The first control portion 130 may receive the start signal ST from the signal detection portion 110, and may receive standby power from the standby power supply portion 115. The first control portion 130 may be driven by the start signal ST. While being powered by standby power, the first control portion 130 may compare the plurality of signals applied at the early stage of driving with a reference current signal and may thus prevent or substantially prevent various elements of a display device from being damaged by an over-current without depending on the main power IC. The first control portion 130 may be provided with standby power by the standby power supply portion 115. The first control portion 130 may compare the plurality of signals applied to the first signal controller 100 at the early stage of driving before the main power IC begins to be driven with the reference current signal, and may decide or determine whether to apply them to the second signal controller 200, the emission driver 500 and the power supply 600. The first control portion 130 may provide the image signal VDATA and various input control signals to the second signal controller 200. The first control portion 130 may provide an emission control signal ECS to the emission driver 500 and may thus control an emission signal output by the emission driver 500. The first control portion 130 may provide the first voltage V1, the second voltage V2 and an over-current protection signal OCP to the blocking portion 170. In response to the over-current protection signal OCP being applied, the blocking portion 170 may allow or block (e.g., not allow, prevent, or substantially prevent) the transmission of the first voltage V1 and the second voltage V2 to the power supply 600, and may thus provide the first voltage V1 and the second voltage V2 to the display panel 1 in an order (e.g., a predefined order).

In response to the main power IC being driven, the first control portion 130 may no longer be able to operate because the standby power supply portion 115 no longer supplies standby power to the sensor of the signal detection portion 110. In response to the main power IC stopping its operation, the standby power supply portion 115 may resume supplying standby power to the first control portion 130, and as a result, the first control portion 130 may be able to continue to control signals.

In response to the over-current protection signal OCP being applied from the first control portion 130, the blocking portion 170 may prevent or substantially prevent the first voltage V1 and the second voltage V2 from being applied to the power supply 600. The blocking portion 170 may include a plurality of switching devices (not illustrated). In response to the over-current protection signal OCP being received, each of the switching devices may prevent or substantially prevent the first voltage V1 and the second voltage V2 from being applied to the display panel 1 via the power supply 600.

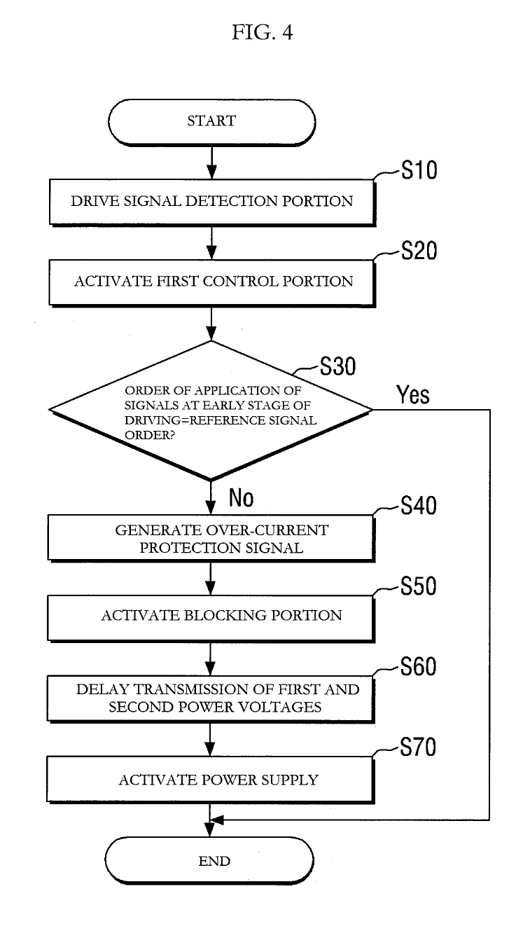

The operation of the first signal controller 100 will, hereinafter, be described in detail with reference to FIG. 4.

FIG. 4 is a flowchart illustrating the operation of the first signal controller illustrated in FIG. 3. Referring to FIG. 4, the signal detection portion 110 of the first signal controller 100 may be powered by standby power from the standby power supply portion 115 and may thus be able to detect a plurality of signals applied to the first signal controller 100 from an external source at an early stage of driving, even though the main power IC is off. The signal detection portion 110 may be driven (S10) by the plurality of signals. In response to the plurality of signals being detected, the signal detection portion 110 may provide the start signal ST to the first control portion 130. In response to the start signal ST being received, the first control portion 130 may be activated (S20). The first control portion 130 may detect the level of a current corresponding to each of the plurality of signals and the timing of the application of the plurality of signals. The first control portion 130 may compare the order of the application of the plurality of signals with an order (e.g., a predefined order) (S30). In response to the order of the application of the plurality of signals coinciding with the order (e.g., the predefined order), the first signal controller 100 may be turned off, and the main power IC may begin to operate to prevent or substantially prevent the flow of an over-current.

On the other hand, in response to the order of the application of the plurality of signals not coinciding with the order (e.g., the predefined order), the first control portion 130 may generate the over-current protection signal OCP (S40), and may provide the over-current protection signal OCP to the blocking portion 170. In response to the over-current protection signal OCP being received, the blocking portion 170 may be activated (S50), and may block (e.g., not allow, prevent, or substantially prevent) or delay the transmission of a signal corresponding to the first voltage V1 or the second voltage V2. As a result, the application of the first power voltage control signal CD and the second power voltage control signal CS to the power supply 600 may be delayed (S60), and thus, the application of the first power voltage ELVSS or the second power voltage ELVDD to the display panel may be delayed.

In response to the first voltage V1 and the second voltage V2 being placed “in order,” in view of a reference signal order provided by a reference signal order provider 135, by being blocked (e.g., not allowed, prevented, or substantially prevented) or delayed for an amount of time (e.g., a predetermined amount of time), the blocking portion 170 may be turned off, and the first power voltage control signal CD and the second power voltage control signal CS may be applied to the power supply 600. In response to the first power voltage control signal CD and the second power voltage control signal CS being received, the power supply 600 may be activated (S70). The first signal controller 100 may be turned off, and the main power IC may begin to operate to prevent or substantially prevent the flow of an over-current.

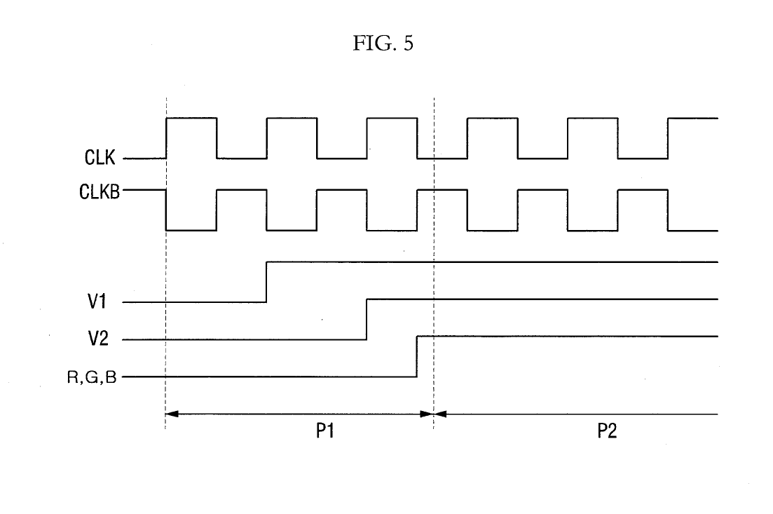

The order of the application of a plurality of signals at an early stage of driving will, hereinafter, be described with reference to FIG. 5.

FIG. 5 is a timing diagram of a plurality of signals applied at an early stage of driving, according to an exemplary embodiment of the present invention. Referring to FIG. 5, a plurality of signals such as the clock signals CLK and CLKB, the first voltage V1, the second voltage V2, and the input image signal (R, G, B) may be applied to the signal detection portion 110 at an early stage of driving. A period between the time when whichever of the plurality of signals is enabled first is enabled and an amount of time (e.g., a predetermined amount of time) after the rest of the plurality of signals are all enabled may be defined as a first period P1, and a period of time that follows the first period P1 may be defined as a second period P2. The amount of time (e.g., the predetermined amount of time) may be set to be equal to, or shorter than, half the period of the clock signal CLK or CLKB.

The signal detection portion 110 may sense the order of the application of the plurality of signals during the first period P1. The plurality of signals may preferably be applied to the signal detection portion 110 in the order of the first voltage V1, the second voltage V2, and the input image signal (R, G, B).

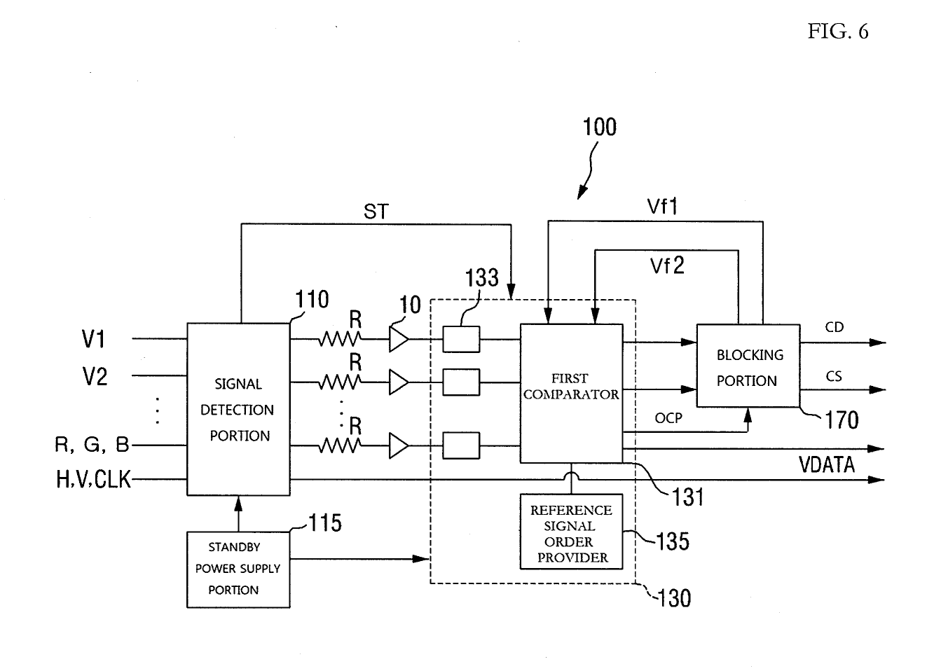

FIG. 6 is a block diagram of a first signal controller according to another exemplary embodiment of the present invention.

Referring to FIG. 6, a first signal controller 100 may include a signal detection portion 110, a standby supply portion 115, a first control portion 130 and a blocking portion 170. The first control portion 130 may include a first comparator 131, a plurality of converters 133 and a reference signal order provider 135.

One or more signals output from the signal detection portion 110 may be amplified by a plurality of resistors R and a plurality of amplifiers 10. Accordingly, the first signal controller 110 can effectively detect and block (e.g., not allow, prevent, or substantially prevent) any weak signals applied thereto. Currents amplified by the amplifiers 10 may be converted into voltages by the converters 133, and the voltages may be provided to the first comparator 131. The first signal controller 100 does not necessarily include all the resistors R, the amplifiers 10 and the converters 133. That is, the first signal controller 100 may selectively include only some of the resistors R, the amplifiers 10 and the converters 133.

The first comparator 131 may receive a plurality of signals applied at the early stage of driving from the signal detection portion 110, may compare the plurality of signals with a voltage provided by the reference signal order provider 135, and may decide or determine whether to block (e.g., not allow, prevent, or substantially prevent) the transmission of the plurality of signals based on the results of the comparison. In other words, in response to the order of the application of the plurality of signals not coinciding with a reference signal order provided by the reference signal order provider 135, the first comparator 131 may provide the over-current protection signal OCP to the blocking portion 170, and may thus block (e.g., not allow, prevent, or substantially prevent) the transmission of one or more signals that are out of order, in view of the reference signal order. The out-of-order signals are not necessarily blocked (e.g., not allowed, prevented, or substantially prevented) permanently. Rather, the out-of-order signals may be delayed or temporarily blocked (e.g., not allowed, prevented, or substantially prevented) to be placed “in order” with other signals applied at the early stage of driving.

The reference signal order provider 135 may provide an order in which the plurality of signals applied at the early stage of driving should be applied from the signal detection portion 110 to the first control portion 130 as the reference signal order. An over-current may be generated at an early stage of driving in response to power being applied “out of order” during a power-up sequence. The reference signal order provider 135 may be driven by the start signal ST, which is provided by the signal detection portion 110, and may provide the reference signal order to the first comparator 131. For example, the reference signal order may be as follows: the first voltage V1, which is applied to the display panel 1 as the first power voltage ELVDD, the second voltage V2, which is applied to the display panel 1 as the second power voltage ELVSS, and the input image signal (R, G, B), which is applied to the display panel 1 as the image signal VDATA. However, the reference signal order is not limited to this example. That is, the reference signal order may be set (e.g., set in advance) to be suited for the characteristics of a display device.

In response to the over-current protection signal OCP being applied from the first comparator 131, the blocking portion 170 may block (e.g., not allow, prevent, or substantially prevent) the transmission of the first power voltage control signal CD and the second power voltage control signal CS to the power supply 600. The blocking portion 170 may include a plurality of switching devices (not illustrated). In response to the over-current protection signal OCP being received, each of the switching devices may prevent or substantially prevent signals corresponding to the first voltage V1 and the second voltage V2 from being transmitted to the power supply 600. An output terminal of the blocking portion 170 may be electrically connected to the first comparator 131. Voltages Vf1 and Vf2 at the output terminal of the blocking portion 170 may be fed back to the first comparator 131 as feedback voltages. The first comparator 131 may decide or determine whether to continue to apply the over-current protection signal OCP to the blocking portion 170 based on the feedback voltages Vf1 and Vf2.

The first comparator 131 may receive the feedback voltages Vf1 and Vf2 from the blocking portion 170. In response to the signals that are blocked (e.g., not allowed, prevented, or substantially prevented) by the blocking portion 170 being placed “in order” with other signals applied at the early stage of driving, in view of the reference signal order provided by the reference signal order provider 135, the blocking portion 170 may be turned off, and the first power voltage signal CD and the second power voltage control signal CS may be provided to the power supply 600. In response to the first power voltage signal CD and the second power voltage control signal CS being received, the power supply 600 may be activated. The first signal controller 100 may be turned off, and the main power IC may begin to operate to prevent or substantially prevent the flow of an over-current.

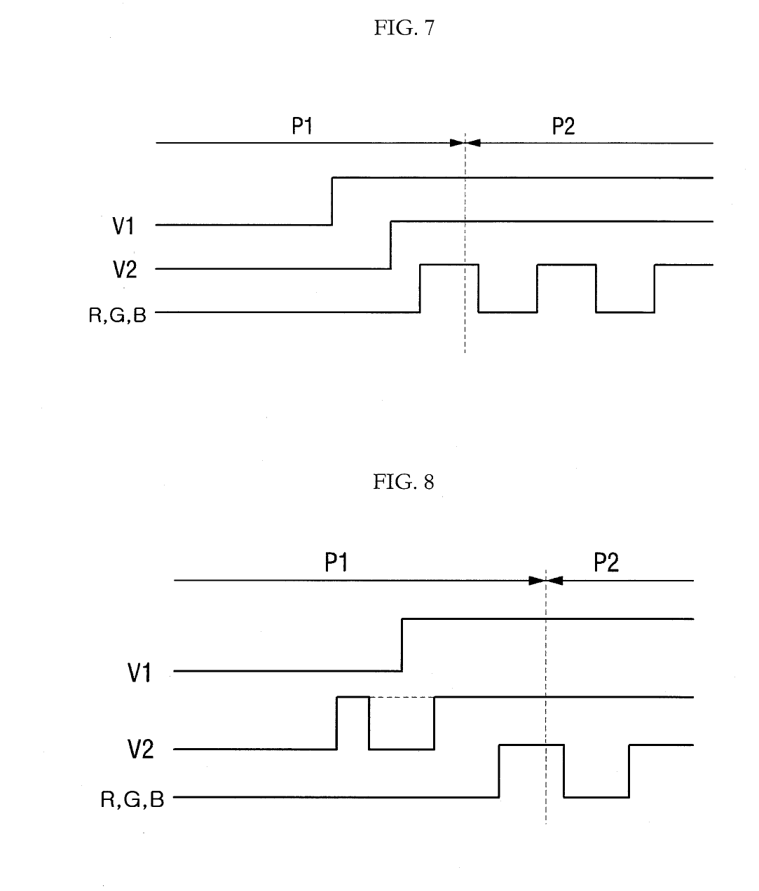

FIGS. 7 and 8 are timing diagrams of a plurality of signals applied at an early stage of driving, according to another exemplary embodiment of the present invention.

Referring to FIG. 7, signals that may cause an over-current to the display panel 1 at an early stage of driving may include the first voltage V1, the second voltage V2, and the input image signal (R, G, B). The input image signal (R, G, B) may be enabled during a first period P1, and may then be disabled. In the case where the timing at which each signal applied to the signal detection portion 110 is all enabled coincides with the reference signal order provided by the reference signal order provider 135, the generation of an over-current may be prevented or substantially prevented, even if there is a signal enabled during the first period P1 and disabled afterwards, like the input image signal (R, G, B) of FIG. 7. The types of the signals that may cause an over-current to the display panel 1 at the early stage of driving may differ from one display device to another display device, and are thus not limited to those set forth herein.

Referring to FIG. 8, in the case where the order of the application of a plurality of signals at an early stage of driving does not coincide with the reference signal order provided by the reference signal order provider 135, the blocking portion 170 may control the order in which the plurality of signals should be applied. In FIG. 8, the second voltage V2 applied to the signal detection portion 110 is represented by a dotted line, and the feedback voltages Vf1 and Vf2 provided by the blocking portion 170 are represented by solid lines. In response to the first voltage V1, the second voltage V2, and the input image signal (R, G, B) being set to be sequentially applied to the display panel 1, as mentioned above with reference to FIG. 6, the display panel 1 may experience an over-current if the second voltage V2 is applied to the display panel 1 before the first voltage V1. To prevent or substantially prevent the generation of an over-current, the blocking portion 170 may block (e.g., not allow, prevent, or substantially prevent) the transmission of the second voltage V2 for an amount of time (e.g., a predetermined amount of time), and may provide the feedback voltage Vf2 to the first controller 131 to notify the first controller 131 of the blocking (e.g., not allowing, preventing, or substantially preventing) of the second voltage V2. In response to the first voltage V1 being applied, the blocking portion 170 may provide a signal corresponding to the second voltage V2 to the second controller 200 because of the second voltage V2 being placed “in order” with the first voltage V1, in view of the reference signal order provided by the reference signal order provider 135.

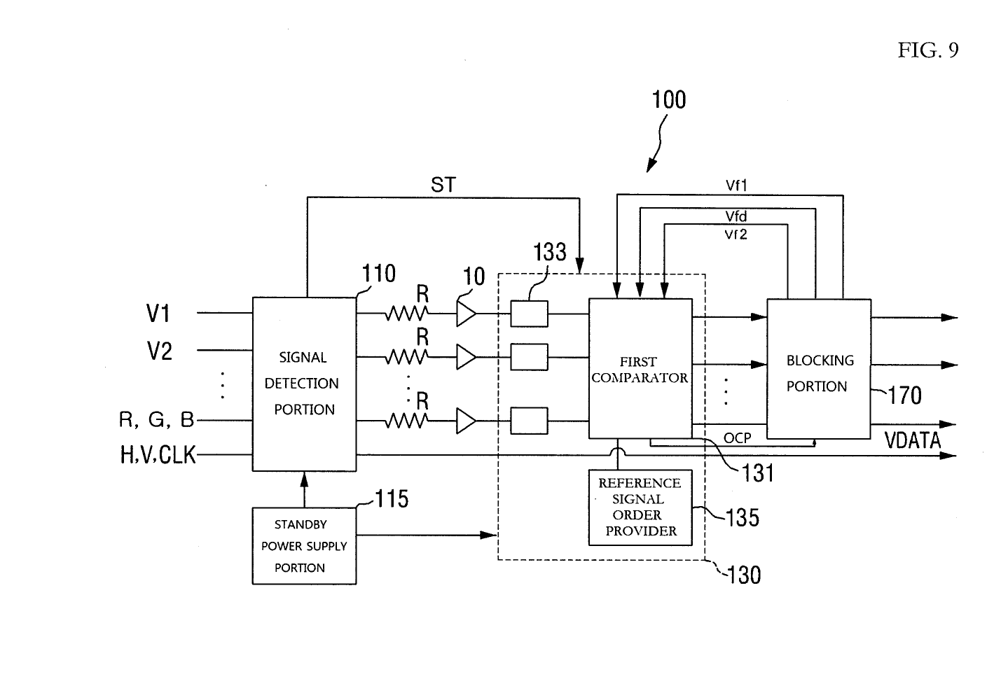

FIG. 9 is a block diagram of a first signal controller according to another exemplary embodiment of the present invention.

The first signal controller of FIG. 9 has a similar structure to that of the first signal controller of FIG. 6, and thus will, hereinafter, be described, focusing mainly on differences with the first signal controller of FIG. 6. Referring to FIG. 9, a first signal controller 100 may include a signal detection portion 110, a standby power supply 115, a first control portion 130, and a blocking portion 170. The first control portion 130 may include a first comparator 131, a plurality of converters 133 and a reference signal order provider 135.

One or more signals output from the signal detection portion 110 may be amplified by a plurality of resistors R and a plurality of amplifiers 10. Accordingly, the first signal controller 110 can effectively detect and block (e.g., not allow, prevent, or substantially prevent) any weak signals applied thereto. Currents amplified by the amplifiers 10 may be converted into voltages by the converters 133, and the voltages may be provided to the first comparator 131. The first signal controller 100 does not necessarily include all the resistors R, the amplifiers 10 and the converters 133. That is, the first signal controller 100 may selectively include only some of the resistors R, the amplifiers 10 and the converters 133.

The first comparator 131 may receive a plurality of signals applied at an early stage of driving from the signal detection portion 110, may compare the plurality of signals with a voltage provided by the reference signal order provider 135, and may decide or determine whether to block (e.g., not allow, prevent, or substantially prevent) the transmission of the plurality of signals based on the results of the comparison. In other words, in response to the order of the application of the plurality of signals, for example, the first voltage V1, the second voltage V2 and the input image signal (R, G, B), not coinciding with a reference signal order provided by the reference signal order provider 135, the first comparator 131 may provide the over-current protection signal OCP to the blocking portion 170, and may thus block (e.g., not allow, prevent, or substantially prevent) the transmission of one or more of the plurality of signals that are out of order, in view of the reference signal order. The out-of-order signals are not necessarily blocked (e.g., not allowed, prevented, or substantially prevented) permanently. Rather, the out-of-order signals may be delayed or temporarily blocked (e.g., not allowed, prevented, or substantially prevented) so as to be placed “in order” with other signals applied at the early stage of driving, in view of the reference signal order.

The reference signal order provider 135 may provide the reference signal order which is an order in which the plurality of signals applied at the early stage of driving should be applied from the signal detection portion 110 to the first control portion 130. An over-current may be generated at the early stage of driving in response to power being applied “out of order” during a power-up sequence. The reference signal order provider 135 may be driven by the start signal ST, which is provided by the signal detection portion 110, and may provide the reference signal order to the first comparator 131. For example, the reference signal order may be as follows: the first voltage V1, which is applied to the display panel 1 as the first power voltage ELVDD, the second voltage V2, which is applied to the display panel 1 as the second power voltage ELVSS, and the input image signal (R, G, B), which is applied to the display panel 1 as the image signal VDATA. However, the reference signal order is not limited to this example. That is, the reference signal order may be set (e.g., set in advance) to be suited for the characteristics of a display device.

In response to the over-current protection signal OCP being applied from the first comparator 131, the blocking portion 170 may block (e.g., not allow, prevent, or substantially prevent) the transmission of the first power voltage control signal CD and the second power voltage control signal CS to the power supply 600, and may also block (e.g., not allow, prevent, or substantially prevent) the transmission of the image signal VDATA to the second signal controller 200. The blocking portion 170 may be electrically connected to the first comparator 131, and may transmit a plurality of feedback voltages Vf1, Vf2 and Vfd to the first comparator 131 to enable the first comparator 131 to decide or determine whether to continue to provide the over-current protection signal OCP to the blocking portion 170.

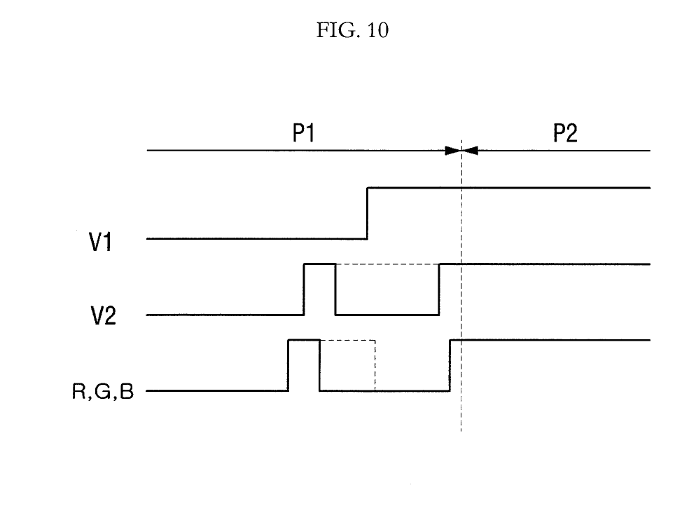

The first comparator 131 may receive the feedback voltages Vf1, Vf2 and Vfd from the blocking portion 170. In response to the signals that are blocked (e.g., not allowed, prevented, or substantially prevented) by the blocking portion 170 being placed “in order” with other signals applied at the early stage of driving, in view of the reference signal order provided by the reference signal order provider 135, the blocking portion 170 may be turned off. As a result, the first power voltage signal CD and the second power voltage control signal CS may be provided to the power supply 600, and the image signal VDATA may be provided to the second signal controller 200. In response to the first power voltage signal CD and the second power voltage control signal CS being received, the power supply 600 may be activated, and may provide the first power voltage ELVDD and the second power voltage ELVSS to the display panel 1. The first signal controller 100 may be turned off, and the main power IC may begin to operate to prevent or substantially prevent the flow of an over-current. A method of blocking (e.g., not allowing, preventing, or substantially preventing) the transmission of signals according to an exemplary embodiment of the present invention will, hereinafter, be described with reference to FIG. 10.

FIG. 10 is a timing diagram of a plurality of signals applied at an early stage of driving, according to another exemplary embodiment of the present invention. Referring to FIG. 10, signals that may cause an over-current to the display panel 1 at an early stage of driving may include the first voltage V1, the second voltage V2 and the input image signal (R, G, B). The types of the signals that may cause an over-current to the display panel 1 at the early stage of driving may vary from one display device to another display device, and are not limited to those set forth herein.

In the case where the order of the application of a plurality of signals at the early stage of driving does not coincide with the reference signal order provided by the reference signal order provider 135, the blocking portion 170 may control the order in which the plurality of signals should be applied. In FIG. 10, the second voltage V2 and the input image signal (R, G, B) applied to the signal detection portion 110 are represented by dotted lines, and the feedback voltages Vf1, Vf2 and Vfd provided by the blocking portion 170 are represented by solid lines. In response to the first voltage V1, the second voltage V2, and the input image signal (R, G, B) being set to be sequentially applied to the display panel 1, as mentioned above with reference to FIG. 6, the display panel 1 may experience an over-current if the second voltage V2 and the input image signal (R, G, B) are applied to the display panel 1 before the first voltage V1. To prevent or substantially prevent the generation of an over-current, the blocking portion 170 may block (e.g., not allow, prevent, or substantially prevent) the transmission of the second voltage V2 and the input image signal (R, G, B) for an amount of time (e.g., a predetermined amount of time), and may provide the feedback voltages Vf1, Vf2 and Vfd to the first controller 131 to notify the first controller 131 of the blocking (e.g., not allowing, preventing, or substantially preventing) of the second voltage V2 and the input image signal (R, G, B). When the first voltage V1 is applied, the blocking portion 170 may identify, from the feedback voltage Vf1, that the second voltage V2 is “in order” with the first voltage V1, in view of a reference signal order (e.g., a predefined reference signal order), and may provide a signal corresponding to the second voltage V2 to the second controller 200.

In response to the application of the first voltage V1, the second voltage V2 and the input image signal (R, G, B) being placed in order with one another, the first period P1 may end, and the main power IC may begin to operate and may control signals applied to the display panel 1.

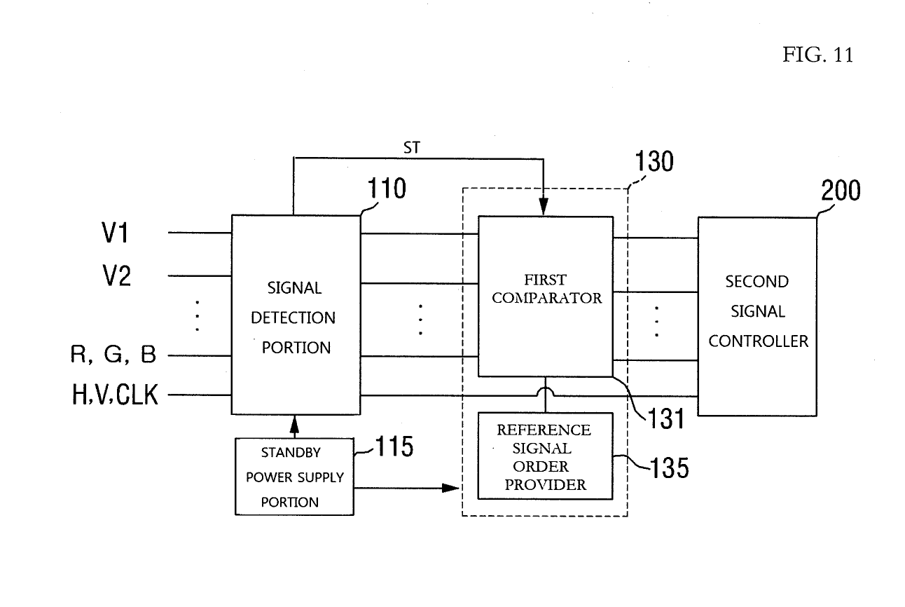

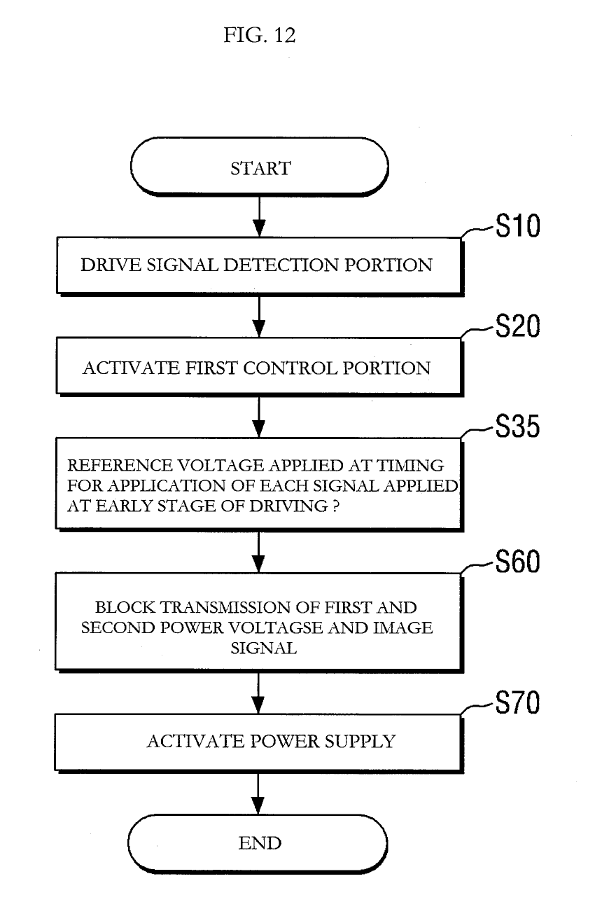

FIG. 11 is a block diagram of a first signal controller according to another exemplary embodiment of the present invention, and FIG. 12 is a flowchart illustrating the operation of the first signal controller illustrated in FIG. 11.

The first signal controller of FIG. 11 has a similar structure to that of the first signal controller of FIG. 6, and thus will, hereinafter, be described, focusing mainly on differences with the first signal controller of FIG. 6. Referring to FIG. 11, a first signal controller 100 may include a signal detection portion 110, a standby power supply 115, a first control portion 130, and a blocking portion 170. The first control portion 130 may include a first comparator 131 and a reference signal order provider 135.

The first comparator 131 may receive a plurality of signals applied at an early stage of driving from the signal detection portion 110, compare the plurality of signals with a voltage provided by the reference signal order provider 135, and decide or determine whether to block (e.g., not allow, prevent, or substantially prevent) the transmission of the plurality of signals based on the results of the comparison. In other words, in response to the order of the application of the plurality of signals such as, for example, the first voltage V1, the second voltage V2 and the input image signal (R, G, B), not coinciding with a reference signal order provided by the reference signal order provider 135, the first comparator 131 may block (e.g., not allow, prevent, or substantially prevent) the transmission of one or more signals that are out of order, in view of the reference signal order. The out-of-order signals are not necessarily blocked (e.g., not allowed, prevented, or substantially prevented) permanently. Rather, the out-of-order signals may be delayed or temporarily blocked (e.g., not allowed, prevented, or substantially prevented) to be placed “in order” with other signals applied at the early stage of driving, in view of the reference signal order.

The reference signal order provider 135 may provide an order in which the plurality of signals applied at the early stage of driving should be applied from the signal detection portion 110 to the first control portion 130 as the reference signal order. The reference signal order provider 135 may be driven by the start signal ST, which is provided by the signal detection portion 110, and may provide the reference signal order to the first comparator 131.

The operation of the first signal controller 100 of FIG. 11 will, hereinafter, be described with reference to FIG. 12. Referring to FIG. 12, the signal detection portion 110 of the first signal controller 100 may be powered by standby power from the standby power supply portion 115 and may thus be able to detect a plurality of signals applied to the first signal controller 100 from an external source at an early stage of driving, even though the main power IC is off. The signal detection portion 110 may be driven (S10) by the plurality of signals. The signal detection portion 110 may provide the start signal ST to the first control portion 130 upon the detection of the detection of the plurality of signals. In response to the start signal ST being received, the first control portion 130 may be activated (S20). In response to the application of the start signal ST to the first control portion 130, the reference signal provider 135 may provide a reference signal order for the application of the first voltage V1, the second voltage V2 and the input image signal (R, G, B) to the first comparator 131 (S35). The first comparator 131 may use an operational amplifier or an AND gate element, which will be described later in detail.

In response to the order of the application of the first voltage V1, the second voltage V2 and the input image signal (R, G, B) not coinciding with the reference signal order, the first comparator 131 may block (e.g., not allow, prevent, or substantially prevent) the transmission of the first voltage V1 and the second voltage V2 to the power supply 600, and may block (e.g., not allow, prevent, or substantially prevent) or delay the transmission of the image signal VDATA to the second signal controller 200 (S60).

In response to the first voltage V1, the second voltage V2 and the input image signal (R, G, B) being placed in order with one another, in view of the reference signal order by the first control portion 130, the power supply 600 and the second signal controller 200 may be activated (S70), and the main power IC may control the generation of an over-current.

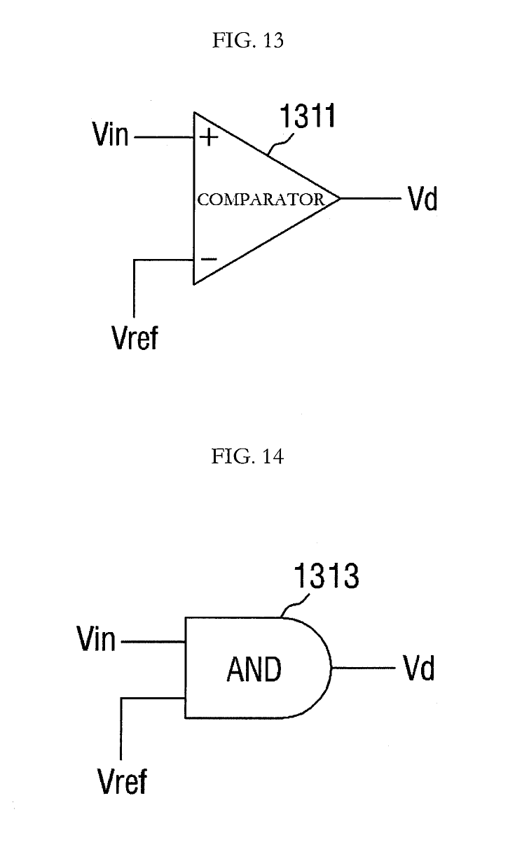

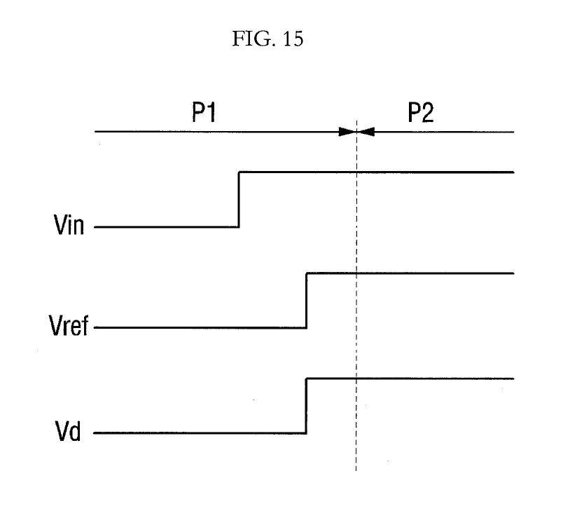

FIGS. 13 and 14 are circuit diagrams of first comparators according to exemplary embodiments of the present invention, and FIG. 15 is a timing diagram illustrating the operation of the first comparator illustrated in FIG. 14.

Referring to FIG. 13, a first comparator 131 may include a comparator 1311, which uses a differential amplifier. The comparator 1311 may compare a reference voltage Vref applied to a negative terminal (−) thereof and an input voltage Vin applied to a positive terminal (+) thereof, and may output the input voltage Vin as an output voltage Vd when the input voltage Vin is higher than the reference voltage Vref. The reference voltage Vref may be a voltage provided by the reference signal order provider 135. The reference signal order provider 135 may continue to apply a high reference voltage Vref to the comparator 1311 until the arrival of a timing for the application of a signal (e.g., a predetermined signal) so that any input voltage Vin lower than the reference voltage Vref can be prevented or substantially prevented from being output from the comparator 1311. However, the present invention is not limited to this example. That is, a plurality of signals applied at an early stage of driving, such as, for example, the first voltage V1, the second voltage V2 and the input image signal (R, G, B), may be output in a defined order (e.g., a predefined order) by using the comparator 1311 in various manners.

Referring to FIG. 14, a first comparator 131 may include an AND operator 1313. The AND operator 1313 may compare a reference voltage Vref and an input voltage Vin, and may output the input voltage Vin as an output voltage Vd when the reference voltage Vref and the input voltage Vin are both enabled. Accordingly, the AND operator 1313 may provide the same or substantially the same benefits as a comparator. In an exemplary embodiment, as many AND operators 1313 as there are signals (such as, for example, the first voltage V1, the second voltage V2, and the input image signal (R, G, B)) applied at an early stage of driving may be provided in the first comparator 131, and the AND operators 1313 may be respectively connected to the wires through which the signals are applied. The reference voltage Vref may be a voltage provided by the reference signal order provider 135. The reference signal order provider 135 may continue to provide a disable signal until the arrival of a timing for the application of a signal (e.g., a predetermined signal), and may provide an enable signal after the application of the signal (e.g., the predetermined signal). Accordingly, the AND operator 1313 may block (e.g., not allow, prevent, or substantially prevent) the transmission of an input voltage Vin that is applied ahead of time.

FIG. 15 is a timing diagram illustrating the operation of the first comparator illustrated in FIG. 14.

Referring to FIG. 15, an input voltage Vin and a reference voltage Vref may be applied to the first comparator 131, and the first comparator 131 may provide an output voltage Vd. Even when the input voltage Vin is applied, the first comparator 131 may not provide the output voltage Vd unless the reference voltage Vref is provided. In response to a signal such as, for example, the first voltage V1, the second voltage V2, or the input image signal (R, G, B), being applied at an early stage of driving as the input voltage Vin and the reference voltage Vref being applied an amount of time (e.g., a predetermined amount of time) after the application of the input voltage Vin, the first comparator 131 may provide the output voltage Vd. In response to the reference voltage Vref is applied, the first period P1 may end, and the main power IC may begin to operate and may prevent or substantially prevent the flow of an over-current.

However, the features of the present invention are not limited to the ones set forth herein. The above and other features of the present invention will become more apparent to one of ordinary skill in the art to which the present invention pertains by referencing the claims.

While the present invention has been particularly shown and described with reference to exemplary embodiments thereof, it will be understood by those of ordinary skill in the art that various changes and modifications may be made therein without departing from the spirit and scope of the present invention as defined by the following claims, and their equivalents. The exemplary embodiments should be considered in a descriptive sense only and not for purposes of limitation.

What is claimed is:

1. A display device, comprising:
a first signal controller configured to be turned on by a first signal among a plurality of signals applied thereto at an early stage of driving, and to output the plurality of signals applied at the early stage of driving in a predefined order; and
a main power integrated circuit (IC) configured to be turned on when each of the plurality of signals applied at the early stage of driving is received,
wherein the first signal controller comprises a standby power supply portion configured to supply standby power to the first signal controller while the main power IC is off.

2. The display device of claim 1, wherein the first signal controller further comprises:
a signal detection portion, configured to detect the first signal and outputs a start signal;
a reference signal order provider, configured to output a reference signal order in which the plurality of signals applied at the early stage of driving should be output when the start signal is received; and
a comparator, configured to, when the start signal is received, output an over-current protection signal when an order of the application of the plurality of signals applied at the early stage of driving does not coincide with the reference signal order output by the reference signal order provider.

3. The display device of claim 2, wherein the first signal controller further comprises:
a blocking portion configured to block the transmission of a plurality of power voltage control signals of the plurality of signals by the comparator for an amount of time when the over-current protection signal is received.

4. The display device of claim 3, wherein the blocking portion is configured to feed the power voltage control signals back to the comparator.

5. The display device of claim 2, wherein the first signal controller further comprises:
a blocking portion configured to block the transmission of a plurality of power voltage control signals of the plurality of signals and an input image signal of the plurality of signals by the comparator for an amount of time when the over-current protection signal is received.

6. The display device of claim 5, wherein the blocking portion is configured to feed the power voltage control signals and the input image signal back to the comparator.

7. The display device of claim 2, wherein the plurality of signals applied at the early stage of driving comprises:
a first power voltage signal;
a second power voltage signal; and
an input image signal,
wherein the first power voltage signal, the second power voltage signal, and the input image signal are sequentially applied to the main power IC.

8. The display device of claim 7, wherein the reference signal order provider is turned off when the signals applied at the early stage of driving are applied to the first signal controller in the predefined order.

9. The display device of claim 7, wherein the standby power supply portion is turned off when the signals applied at the early stage of driving are applied to the main power IC in the predefined order.

10. The display device of claim 2, wherein the comparator comprises a differential amplifier.

11. The display device of claim 2, wherein the comparator comprises an AND operator.

12. The display device of claim 1, further comprising:
a second signal controller configured to be driven by the main power IC, to be connected to the first signal controller, and to provide an input image signal to a display panel.

13. A method of driving a display device, the method comprising:
allowing a first signal controller to be turned on by a first signal, among a plurality of signals applied thereto at an early stage of driving;
determining whether an order of the application of the plurality of signals applied at the early stage of driving coincides with a predefined order;
outputting the signals applied at the early stage of driving in the predefined order; and
allowing a main power IC to be turned on each of the signals applied at the early stage of driving is received,
wherein the first signal controller comprises a standby power supply portion, which supplies standby power to the first signal controller while the main power IC is off.

14. The method of claim 13, wherein the first signal controller further comprises:
a signal detection portion, which detects the first signal and outputs a start signal;
a reference signal order provider, which outputs a reference signal order in which the signals applied at the early stage of driving should be output when the start signal is received; and
a comparator, which, when the start signal is received, outputs an over-current protection signal when an order of the application of the signals applied at the early stage of driving does not coincide with the reference signal order output by the reference signal order provider.

15. The method of claim 14, wherein the first signal controller further comprises:
a blocking portion which blocks the transmission of a plurality of power voltage control signals of the plurality of signals by the comparator for an amount of time when the over-current protection signal is received.

16. The method of claim 15, wherein the blocking portion feeds the power voltage control signals back to the comparator.

17. The method of claim 14, wherein the first signal controller further comprises:
a blocking portion which blocks the transmission of a plurality of power voltage control signals of the plurality of signals and an input image signal of the plurality of signals by the comparator for an amount of time when the over-current protection signal is received.

18. The method of claim 17, wherein the blocking portion feeds the power voltage control signals and the input image signal back to the comparator.

19. The method of claim 14, wherein the plurality of signals applied at the early stage of driving comprises:
a first power voltage signal;
a second power voltage signal; and
an input image signal,
wherein the first power voltage signal, the second power voltage signal, and the input image signal are sequentially applied to the main power IC.

20. The method of claim 19, wherein the reference signal order provider is turned off when the signals applied at the early stage of driving are applied to the first signal controller in the predefined order and the standby power supply portion is turned off when the signals applied at the early stage of driving are applied to the main power IC in the predefined order.
